(19) United States
(12) Patent Application Publication
(10) Pub. No.: US 2017/0331896 A1
(43) Pub. Date: Nov. 16, 2017

(54) METHODS AND SYSTEMS FOR PROCESSING ASSETS

(71) Applicant: DE LA RUE INTERNATIONAL LIMITED, Basingstoke (GB)

(72) Inventors: Barry HOLLOWAY, Basingstoke (GB); Martin ESTCOURT, Basingstoke (GB); Richard BELLAIRS, Basingstoke (GB)

(73) Assignee: DE LA RUE INTERNATIONAL LIMITED, Basingstoke (GB)

(21) Appl. No.: 15/154,291

(22) Filed: May 13, 2016

(51) Int. Cl. H04L 29/08; H04L 9/12; H04L 9/32

(52) U.S. Cl. CPC H04L 67/12; H04L 67/104; H04L 9/12; H04L 9/32

(57) ABSTRACT

A computer-implemented method for processing an asset within a supply chain includes: providing a first distributed ledger maintained by nodes within a first distributed consensus network; providing a second distributed ledger maintained by nodes within a second distributed consensus network; creating the asset by a supply chain first entity associated with at least one node within the first network, and providing a digital certificate uniquely associated with the asset for authentication; creating a first transaction record in the first distributed ledger representing an asset transfer and its associated digital certificate from the first entity to a supply chain second entity associated with at least one node within the first network; and creating a second transaction record in the second distributed ledge representing an asset transfer and its associated digital certificate from the second entity to a supply chain third entity associated with at least one node within the second network.

### FIELD OF THE INVENTION

The present invention generally relates to transferring assets within a supply chain, and in particular the use of distributed consensus networks for this purpose.

### BACKGROUND TO THE INVENTION

In commerce, a supply chain is a collection of entities which collaborate to design, manufacture and distribute to the public a particular good or asset. Supply chains entities may include supply chain owners or designers, manufacturers, distributors, retailers and consumers. Usually a supply chain owner creates a design or blueprint of an item to be produced and arranges for supply chain entities such as manufacturers, distributors, retailers to produce and distribute the items to the consumers representing the public.

For example, a supply chain owner may give the blueprint to one or many manufacturers and specify how many items they can legitimately produce. A manufacturer then produces the items, packages them and transfers them to one or more distributors. A distributor receives the items from the manufacturer and transfers them to other distributors or retailers. A retailer receives the items from the distributor, unpacks the items from packages and sells them individually to consumers. Consumers buy the items from the retailer. Subsequently they may re-sell them on secondary market to other consumers.

An ever present problem of supply chain transactions is to guarantee that only the legitimately produced and distributed items are sold to consumers. In order to guarantee this, all of the entities in the legitimate supply chain should be able to verify that the goods are authentic, i.e. that a particular item was produced legitimately and followed its path through the legitimate supply chain. In other words, all of the entities in the legitimate supply chain should be able to verify the provenance of an item. At present, this problem is addressed by relying on physical security and trust to the previous owner. In effect the supply chain is a chain of ownership and the new owner trusts the previous owner in its ability to verify provenance.

Conventionally, the ownership of assets could be entered into a centralised register. This leads to security weaknesses, however, since the centralised register is the single point of verification. One alternative to a centralised register is to rely on physical tokens (such as a deed). The holder of the token is deemed to be the owner of the asset. This provides an unambiguous method of proving the ownership of an asset. However, such physical objects are cumbersome and insecure, as they can be lost, stolen or duplicated.

There is need for a more secure way of transferring and authenticating items within the supply chain.

### SUMMARY OF THE INVENTION

In a first aspect of the present invention, there is provided a computer-implemented method for processing an asset within a supply chain, the method comprising:

providing a first distributed ledger, the first distributed ledger being maintained by nodes within a first distributed consensus network;

providing a second distributed ledger, the second distributed ledger being maintained by nodes within a second distributed consensus network,

creating the asset by a first entity of the supply chain, the first entity being associated with at least one node within the first distributed consensus network, and providing a digital certificate uniquely associated with the asset for authentication of the asset;

creating a first transaction record in the first distributed ledger, the first transaction record representing a transfer of the asset and its associated digital certificate from the first entity to a second entity of the supply chain, the second entity being associated with at least one node within the first distributed consensus network; and

creating a second transaction record in the second distributed ledger, the second transaction record representing a transfer of the asset and its associated digital certificate from the second entity to a third entity of the supply chain, the third entity being associated with at least one node within the second distributed consensus network.

According to the first aspect, any asset information which a first entity of the supply chain such as an owner or a manufacturer would not want exposed to consumers may be held within a first (e.g. private) distributed consensus network. A second entity, representing a retailer of the supply chain for example, may transfer an asset to a third entity representing a consumer for example. Advantageously, in order for consumers to track validity of sales of items, the private distributed consensus network is extended to a second (e.g. public) distributed consensus network. The first and second distributed consensus networks are thus distinct networks which are linked to each other, that is connected in an appropriate manner, at the point of as transaction (for example from a retailer to a consumer). The first and second distributed consensus networks have respective nodes which may be configured to be accessed by authorised entities of a supply chain.

In particular, the present invention provides a solution to the supply chain security (asset provenance) problem whilst moving the trust relationship onto distributed consensus ledgers which record the proof of ownership of the assets. An asset may be an item such as physical product or a digital product such as software. Alternatively, the asset may be a license to manufacture an item or a license to replicate a tangible or intangible product (e.g. software).

A distributed consensus ledger provides authentication of transfer of ownership actions and guarantees immutability and auditability of history of ownership. By ‘distributed consensus network’ we mean a decentralised, immutable, peer-to-peer network such as a blockchain. In essence, blockchain technology is a distributed ledger. It is the technology that the crypto-currency Bitcoin was built upon and it allows peer-to-peer communication, decentralised ownership and authentication of transactions.

Advantageously, the present invention allows for a private distributed consensus network whereby each node may be trusted, unlike the public nature of a system such as bitcoin blockchain. Additionally, the private distributed consensus network may use a proof-of-work principle of the bitcoin blockchain for example to ensure that data in the chain can be trusted. This means that each transaction must be validated by a consensus of other nodes on the network to be able to be added to the blockchain.

A distributed consensus network such as a blockchain has a number of advantages over traditional centralised databases. In particular, communication may be done directly between two nodes (i.e. two participants) of the network, removing reliance on a central authority and thus increasing security. Further, a distributed consensus network is robust. For example, the loss of a node within the blockchain network due to maintenance or power failure has no impact over the overall distributed consensus network as a whole. Further still, transactions within a distributed consensus network are difficult to falsify since the nodes in a distributed consensus network are typically required to perform a computationally complex task which must be shared with other nodes to verify the result (e.g. a ‘proof-of-work’ or a ‘proof-of-stake’).

According to the first aspect of the invention, transactions are deemed complete after the receiving entity has received both the digital certificate (e.g. a digital token) as well as the asset (e.g. a physical item). Entities within the supply chain may have control over one or more servers, which are able to act as nodes on one of the distributed consensus (i.e. peer-to-peer) networks. Every node within a network may be capable of receiving and sending digital certificates to one or more of the other nodes.

A transaction record on the distributed ledger may include for example a transaction ID and a public key of the node associated with the entity receiving the asset. Preferably, the transaction record includes a public key associated with both the sender and the receiver.

Possession of a digital certificate and its associated asset indicates that: a. the asset was produced with the authorisation of the supply chain owner, and b. the asset has been transferred from an authorised supplier. Transactions of digital certificates are recorded on a cryptographically secure, peer-to-peer distributed transaction ledger (such as a blockchain) that is shared by the supply chain entities. The access permissions to the blockchain are controlled by the supply chain owner. Typically, entities such as supply chain owner, manufacturer or retailer are associated with a private distributed consensus network whilst entities such as consumers are associated with a public distributed consensus network which distinct from the private distributed consensus network, and linked at the point of transaction (for example from a retailer to a consumer).

In some embodiments, the first and second distributed consensus networks may be respectively implemented as one or more blockchains, wherein the one or more blockchains of the first (e.g. private) distributed consensus network are implemented as one or more two-way pegged sidechains to a parent chain represented by a blockchain of the second (e.g. public) distributed consensus network. Advantageously, pegged sidechains enable assets to be transferred between multiple blockchains. Since the sidechains are separate to the parent chain, the present invention enables the privacy of the first distributed consensus network so that consumers in the public blockchain for example only have access to selected data associated with assets (to verify authenticity of an asset for example).

In particular, a distributed register approach as employed according to the invention can use a distributed consensus system such as that underlying Bitcoin, the technical background of which is described in Satoshi Nakamoto, “Bitcoin: A Peer-to-Peer Electronic Cash System” (2008) which is incorporated herewith by reference. Sidechains which enable bitcoins as well as other ledger assets to be transferred between blockchains are described in Adam Back et al., “Enabling Blockchain Innovations with Pegged Sidechains” (2014) which is also incorporated by reference. A sidechain is a blockchain that can validate data from other blockchains. A two-way peg refers to any mechanism by which an asset may be transferred between the linked chains and back. A pegged sidechain is a sidechain whose assets can be imported from and returned to other chains; that is a sidechain that supports two-way pegged assets.

A two-way pegged sidechain enables assets to be transferred either way between the first and second networks. Despite bidirectional transferability of assets, the first and second distributed consensus networks are isolated such that in case of a cryptographic break in the sidechain for example, the damage is confined to the sidechain itself.

The transfer of an asset (such as an item or a license to manufacture an item), from a private to a public blockchain for example ensures ownership can be tracked by all entities within the supply chain. At the same time, however, a consumer within the public chain will not have access to the data held within the private blockchain. In preferred embodiments, the chains are preferably distinct blockchains in order to provide security and separation of issues in terms of the functions they provide. The distinct blockchains are linked so that assets within the private blockchain may be moved to a node within the public blockchain. In preferred embodiments, only a retailer may transfer a product from the private chain to the public chain. Accordingly, all assets that exist in the public chain must have been created and transferred from the private blockchain to the public blockchain. Optionally, the second transaction record may be recorded in the private distributed ledger (as well as the public distributed ledger).

In some embodiments, the method further comprises the step of creating a third transaction record in the second distributed ledger, the third transaction record comprising a third transaction identifier, the asset identifier and the identifier of a fourth entity of the supply chain associated with a node within the second distributed consensus network. In other words, consumers may transfer products between each other. Advantageously, consumers can check the validity of an asset by inspecting the public blockchain for example, and accessing the ownership history back to the transfer by the retailer to the public blockchain.

In some embodiments, the method further comprises creating a fourth transaction record respectively in the second distributed ledger, the fourth transaction record representing a transfer of the asset and its associated digital certificate from the third or fourth entity back to the second entity. For example, a consumer who owns the asset may transfer the asset back into the private blockchain. This may be important in the case of returns of faulty items from a consumer to retailer for example. It will be understood that the fourth transaction record may be recorded in the private distributed ledger (as well as the public distributed ledger).

In some embodiments, associating the digital certificate with the asset may comprise generating a unique identification code from one or more properties of the digital certificate and applying the unique identification code to the asset. In alternative embodiments, associating the digital certificate with the asset may comprise generating a unique identification code from one or more properties of the asset and incorporating the code in the digital certificate. Providing a digital certificate such as a digital token may comprise signing the digital certificate with a secret key of the first entity, wherein the secret key has a corresponding public key. Advantageously, providing a unique association between an asset and its digital certificate increases security of the system as legitimate transfers of the assets must be accompanied by the associated digital certificate.

In some embodiments, a public node in the second distributed consensus network may be configured to access a predetermined node, in the first distributed consensus network in order to authenticate an asset. The predetermined node is typically associated with the supply chain owner in order to enable a consumer associated with the public node for example to access selected data related to authenticity of an asset for example and thus provide a further security advantage.

In a second aspect of the present invention, a system comprises a processor and a memory in communication with the processor, the memory storing instructions which, when executed by the processor, cause the processor to perform a method as described above.

In a third aspect of the present invention, a supply chain comprises a plurality of entities, wherein an asset is processed according to a method as described above. Typically a supply chain comprises a collection of entities including supply chain owners or designers, manufacturers, distributors, retailers and consumers. Advantageously, with the supply chain of this aspect of the invention it is possible to transfer legitimate assets between the various entities as well as detect counterfeited and diverted goods.

According to a fourth aspect of the present invention, there is provided for processing an asset within a supply chain comprising one or more entities, the system comprising:

a first distributed ledger being maintained by nodes within a first distributed consensus network; and

a second distributed ledger being maintained by nodes within a second distributed consensus network,

wherein a first entity associated with at least one node within the first distributed consensus network is configured to create an asset;

wherein the first distributed ledger being is configured to record a first transaction record representing a transfer of the asset from the first entity to a second entity of the supply chain; and

wherein the second distributed ledger is configured to record a second transaction record representing a transfer of the asset from the second entity to a third entity of the supply chain, the third entity being associated with at least one node within the second distributed consensus network,

wherein only the second entity is the only entity of the supply chain associated with at least one node within the first distributed consensus network, which may transfer the asset and its associated digital to the third entity,

wherein the second entity is the only entity of the supply chain associated with at least one node within the first distributed consensus network, which may transfer the asset and its associated digital to the third entity.

In preferred embodiments of the fourth aspect, the first entity is further configured to provide a digital certificate uniquely associated with the asset for authentication of the asset. Advantageously, providing a unique association between an asset and its digital certificate increases security of the system as legitimate transfers of the assets must be accompanied by the associated digital certificate.

In a fifth aspect of the present invention, there is provided a system for processing an asset within a supply chain comprising one or more entities, wherein each entity of the supply chain is associated with at least one node of a distributed consensus network, the distributed consensus network being configured to maintain a distributed ledger of asset transactions between entities of the supply chain;

wherein a first entity of the supply chain is associated with a first node of the distributed consensus network;

wherein the first node is configured to define a second entity of the supply chain and to associate at least one node of the distributed consensus network with the second entity, and

wherein the distributed ledger is maintained by nodes within the distributed consensus network except for at least one node.

According to the fifth aspect, there is provided a solution to the supply chain security (asset provenance) problem whilst moving the trust relationship onto a distributed consensus ledger which records the proof of ownership of the assets. An asset may be an item such as physical product or a digital product such as software. Alternatively, the asset may be a license to manufacture an item or a license to replicate a tangible or intangible product (e.g. software).

Some advantages and preferred embodiments are now described with reference to the fifth aspect.

Advantageously, the first node is configured to define a second entity of the supply chain and to associate at least one node of the distributed consensus network with the second entity. In other words, the first node has the function of being a ‘control’ node over the distributed consensus network. Further, the distributed ledger is maintained by nodes within the distributed consensus network except for at least one node, which is a ‘non-transactional’ node in that it is not used to validate transaction records. This is in contrast to conventional networks such as blockchains for example where all nodes have the same function of ‘transactional’ nodes.

In preferred embodiments the distributed consensus network includes a dedicated reporting node which may be the non-transactional node. A dedicated reporting node is used to access information on the ledger and may be a publicly accessible node for example. In some cases the dedicated reporting node is used to authenticate an item for example. It will be appreciated that the first node (which is the ‘control’ node) may or may not be a non-transactional node. In other words, the function of the non-transactional node may be a dedicated reporting node in order to enhance system performance, Further, the first node (which is the ‘control’ node) may or may not be a dedicated reporting node.

Preferably, not all entities associated with nodes of the network are authorised to perform the same functions associated with an asset, such as for example manufacturing an item of a specific type, transferring the asset to another entity, or receiving an asset from another entity. In particular, the first entity associated with a ‘control’ node authorises other entities into the supply chain and defines their functions or permissions. This is in contrast to conventional networks used for asset transactions wherein every node of the network has the same function or permission associated with an asset. Accordingly, the security of the system may be increased over conventional systems by associating supply chain entities with a distributed consensus network, using predefined functions which differ between entities according to their roles within the supply chain and controlling this association by a dedicated ‘control’ node.

In preferred embodiments, the distributed consensus network may be respectively configured to be maintained via an abstract (or abstraction) layer for example. In other words, an abstract layer may be used to configure the underlying blockchain technology.

The distributed ledger may be configured to record a transaction representing a transfer of the asset and a digital certificate uniquely associated with the asset. Accordingly, transactions are deemed complete after the receiving entity has received both the digital certificate (e.g. a digital token) as well as the asset (e.g. a physical item). Entities within the supply chain may have control over one or more servers, which are able to act as nodes on one of the distributed consensus (i.e. peer-to-peer) networks. Any node within a network except the non-transactional node or nodes may be capable of receiving and sending digital certificates to one or more of the other nodes.

A transaction record on the distributed ledger may include for example a transaction ID and a public key of the node associated with the entity receiving the asset. Preferably, the transaction record includes a public key associated with both the sender and the receiver.

Preferably, each entity is defined by an entity ID, and address and an attribute. For example, the first entity comprises a first entity ID, a first entity address and a first entity attribute, the first entity attribute comprising at least its association with the first node, and wherein the second entity comprises a second entity ID, a second entity address and a second entity attribute. The first entity attribute indicates for example that the first entity is the owner which ‘controls’ the network, in contrast to the second entity (as indicated by the second entity attribute). It will be appreciated that an entity may comprise one or more addresses (as each node associated with the entity for example may have one or more addresses).

Associating the second entity with at least one node of the distributed consensus network may comprise generating a secret key having a corresponding public key, wherein a public key hash stores a digital certificate of an asset which has been transferred to the further entity.

In some cases, associating an entity comprises generating a secret key without a corresponding public key, so that the recordal of a transfer from the further entity cannot be recorded in the distributed ledger. This alternative implementation allows for asset destruction when an asset reaches the end of its life which may be particular importance for tracking high value assets such as cars or bank notes. Destruction of an asset is achieved for example by transferring the asset to a known address with no private keys which thus cannot transfer the asset further.

Preferably, the asset has a unique asset identifier accessible at any node of the distributed consensus network for authenticating the asset using the distributed ledger. In example embodiments, each entity of the supply chain is associated with one or more users.

According to a sixth aspect of the invention, there is provided a method of authenticating an asset using a system as described above with reference to the fifth aspect.

According to a seventh aspect of the invention, there is provided a method of processing an asset within a supply chain comprising one or more entities, the method comprising the steps of: associating each entity of the supply chain with at least one node of a distributed consensus network, the distributed consensus network being configured to maintain a distributed ledger of asset transactions between entities of the supply chain; associating a first entity of the supply chain with a first node of the distributed consensus network; configuring the first node to define a second entity of the supply chain and to associate at least one node of the distributed consensus network with the second entity, and maintaining the distributed ledger is by nodes within the distributed consensus network except for at least one node.

Preferably, the method according to the seventh aspect further comprises the step of providing a digital certificate uniquely associated with the asset for authentication of the asset. In some embodiments, associating the digital certificate with the asset may comprise generating a unique identification code from one or more properties of the digital certificate and applying the unique identification code to the asset. In alternative embodiments, associating the digital certificate with the asset may comprise generating a unique identification code from one or more properties of the asset and incorporating the code in the digital certificate. Providing a digital certificate such as a digital token may comprise signing the digital certificate with a secret key of the first entity, wherein the secret key has a corresponding public key. Advantageously, providing a unique association between an asset and its digital certificate increases security of the system as legitimate transfers of the assets must be accompanied by the associated digital certificate.

In a eight aspect of the present invention, a system comprises a processor and a memory in communication with the processor, the memory storing instructions which, when executed by the processor, cause the processor to perform a method as described with reference to the sixth or seventh aspect.

In a ninth aspect of the present invention, there is provided a system for processing an asset within a supply chain comprising at least three entities, wherein a first entity is configured to authorise a second entity to perform a first function associated with the asset and the first entity is further configured to authorise a third entity to perform a second function associated with the asset, the second function being different from the first function, and wherein each entity of the supply chain is associated with at least one node of a distributed consensus network configured to maintain a distributed ledger of asset transactions between the entities.

Accordingly, the ninth aspect provides a solution to the supply chain security (asset provenance) problem whilst moving the trust relationship onto a distributed consensus ledger which records the proof of ownership of the assets. An asset may be an item such as physical product or a digital product such as software. Alternatively, the asset may be a license to manufacture an item or a license to replicate a tangible or intangible product (e.g. software).

Some advantages and preferred embodiments are now described with reference to the ninth aspect.

Advantageously, not all entities associated with nodes of the network are authorised to perform the same functions associated with an asset, such as for example manufacturing an item of a specific type, transferring the asset to another entity, or receiving an asset from another entity. By granting authorisations to other nodes, the first node has the function of being a ‘control’ node over the distributed consensus network. This is in contrast to conventional networks used for asset transactions wherein every node of the network has the same permissions or functions associated with an asset. The security of the system is increased over conventional systems by associating supply chain entities with a distributed consensus network and using predefined functions which differ between entities according to their roles within the supply chain.

Preferably, the distributed ledger is configured to record a transaction representing a transfer of the asset and a digital certificate uniquely associated with the asset. Accordingly transactions are deemed complete after the receiving entity has received both the digital certificate (e.g. a digital token) as well as the asset (e.g. a physical item). Entities within the supply chain may have control over one or more servers, which are able to act as nodes on one of the distributed consensus (i.e. peer-to-peer) networks. Every node within the distributed consensus network may be capable of receiving and sending digital certificates to one or more of the other nodes.

A transaction record on the distributed ledger may include for example a transaction ID and a public key of the node associated with the entity receiving the asset. Preferably, the transaction record includes a public key associated with both the sender and the receiver.

Preferably, the first function or the second function associated with the asset represents converting a license to manufacture an item into the digital certificate.

Accordingly, possession of a digital certificate and its associated asset indicates that: a. the asset was produced with the authorisation of the supply chain owner, and b. the asset has been transferred from an authorised supplier. Transactions of digital certificates are recorded on a cryptographically secure, peer-to-peer distributed transaction ledger (such as a blockchain) that is shared by the supply chain entities. Access permissions to the blockchain may be controlled by a supply chain owner for example.

The first or second function associated with the asset may be, for example, one of the following: manufacturing an item of a specific type, transferring the asset to another entity, receiving an asset from another entity, licensing the permission to incorporate the item as a component in a another item (e.g. loading software onto a laptop), selling an item.

Typically, an entity of the supply chain comprises an entity ID, an entity address and at least one entity attribute. It will be appreciated that an entity may comprise one or more addresses (as each node associated with the entity for example may have one or more addresses).

Preferably, the first entity is further configured to authorise a new node to connect to the distributed consensus network, the new node for association with a fourth entity to be comprised in the supply chain. For example, associating the fourth entity comprises generating a secret key having a corresponding public key, wherein a public key hash stores a digital certificate of an asset which has been transferred to the further entity.

According to an tenth aspect of the present invention, there is provided a system for processing an asset within a supply chain comprising one or more entities, wherein each entity of the supply chain is associated with at least one node of a distributed consensus network configured to maintain a distributed ledger for recording asset transactions between the entities, wherein a first entity of the supply chain is configured to authorise a new node to connect to the distributed consensus network, the new node for association with a further entity to be comprised in the supply chain, wherein associating the further entity comprises generating a secret key without a corresponding public key, so that a transaction from the further entity cannot be recorded in the distributed ledger.

Advantageously, generating a secret key without a corresponding public key, allows for asset destruction when an asset reaches the end of its life which may be particular importance for tracking high value assets such as cars or bank notes. Destruction of an asset is achieved for example by transferring the asset to a known address with no private keys which thus cannot transfer the asset further.

Preferably, the asset has a unique asset identifier accessible at any node of the distributed consensus network for authenticating the asset using the distributed ledger. In example embodiments, each entity of the supply chain is associated with one or more users.

According to a eleventh aspect of the invention, there is provided a method of authenticating an asset using a system as described above with reference to the tenth and eleventh aspects.

According to a twelfth aspect of the invention, there is provided a method of processing an asset within a supply chain, the supply chain comprising at least three entities, the method comprising the steps of: associating each entity of the supply chain with at least one node of a distributed consensus network, the distributed consensus network being configured to maintain a distributed ledger of asset transactions between the entities, and configuring a first entity to authorise a second entity to perform a first function associated with the asset and to authorise a third entity to perform a second function associated with the asset, the second function being different from the first function.

Preferably, the method according to the twelfth aspect further comprises the step of providing a digital certificate uniquely associated with the asset for authentication of the asset. In some embodiments, associating the digital certificate with the asset may comprise generating a unique identification code from one or more properties of the digital certificate and applying the unique identification code to the asset. In alternative embodiments, associating the digital certificate with the asset may comprise generating a unique identification code from one or more properties of the asset and incorporating the code in the digital certificate. Providing a digital certificate such as a digital token may comprise signing the digital certificate with a secret key of the first entity, wherein the secret key has a corresponding public key. Advantageously, providing a unique association between an asset and its digital certificate increases security of the system as legitimate transfers of the assets must be accompanied by the associated digital certificate.

In a thirteenth aspect of the present invention, a system comprises a processor and a memory in communication with the processor, the memory storing instructions which, when executed by the processor, cause the processor to perform a method as described with reference to the eleventh or twelfth aspect.

In a fourteenth aspect of the present invention, a supply chain comprises a plurality of entities, wherein an asset is processed according to any of the methods described above. Typically a supply chain comprises a collection of entities including supply chain owners or designers, manufacturers, distributors, retailers and consumers. Advantageously, with the supply chain of this aspect of the invention it is possible to transfer legitimate assets between the various entities as well as detect counterfeited and diverted goods.

### BRIEF DESCRIPTION OF THE DRAWINGS

Examples of the present invention will now be described with reference to the accompanying drawings, where:

FIG. 1 is a schematic representation of a method according to a first aspect of the invention;

FIG. 2 schematically illustrates an exemplary distribution of supply chain entities across the private and public distributed consensus networks;

FIG. 3 illustrates an exemplary transfer of assets between entities associated with nodes of a private distributed consensus network;

FIG. 4 schematically shows an exemplary structure of an entity;

FIG. 5 illustrates an example scenario in a supply chain;

FIGS. 6A and 6B show alternative ways of creating a digital certificate uniquely associated with an asset; and

FIG. 7 schematically represents an implementation wherein a blockchain ledger may be used for each order or transaction.

### DESCRIPTION OF EMBODIMENTS

The present invention makes use of two distributed ledgers respectively maintained by two distributed consensus networks in transferring data between entities of a supply chain. The first and second distributed consensus networks may be respectively be private network and public network. The first and second ledgers may then be respectively referred to as a private ledger and a public ledger. Each distributed ledger comprises a linked list of blocks (that is, a blockchain). Each block (aside from the original block) comprises a reference to a previous block, and a number of transaction records.

Each distributed consensus network comprises a number of nodes in communication with one another. Each of the entities of a supply chain typically has one or more nodes associated with it, and there may be additional nodes which are not associated with an entity. Each node in a distributed consensus network typically maintains a copy of the ledger in that network, though it could alternatively be a ‘light client’ that relies on an entity's server node to access the network.

When a node in a distributed consensus network wishes to change the state of the ledger of that network (that is, transfer the intrinsic blockchain tokens from one address to another), it creates and transmits a value transaction record to other nodes in the network. Over time, a number of transaction records (which will typically be unrelated, and will have been created by different nodes) are bundled together by one of the nodes to form a block. For security purposes and prevention of fraud, the block may also include a proof-of-work based on a property of the block. In an alternative, there may be a proof-of-stake. In the case of a proof-of-work, it would be configured to be difficult to find but easy to verify once found. The block is then propagated to other nodes in the network, which each checking and appending it to the end of the ledger. Thus each node has a full copy of all transaction records that have been accepted in the distributed consensus network.

A transaction commit time between blocks is the delay imposed to enable nodes on the network to confirm the transaction and achieve consensus. A transaction commit time can be controlled when a blockchain is created. Preferably, the transaction commit time for a blockchain used by the present invention is 15 seconds or more.

Each transaction record comprises a number of fields. For example, a destination field may be provided, to indicate a subsequent entity which is to become responsible for the transaction record, that is, the address of the entity that receives the blockchain tokens, and who would then sign to transact them with another address. Each transaction record may also comprise body data, which relates to some data intended to be transferred from one entity to another. The body data may comprise one or more key-value pairs, where the key identifies the nature of the data and the value gives the value of the data. In this way, the blockchain transactions become the means of carrying more fundamental body data, as well as being used as a means of transferring value. Therefore, blockchain transactions in this context would imply changes to the body data in the record by one entity and or transferring the record to another entity to makes changes or updates to the body data.

Once a transaction record has been included in a block which has been confirmed, each node in the distributed consensus network has a copy of it. Each node or light client therefore has access to a copy of the body data of each transaction record. In practice, these can form a data source. By identifying the most recent transaction record that has a given key, the current value corresponding to that key can be identified.

The value corresponding to a key can also be changed by creating a further transaction record having the same key and a new value included in a subsequent block that is confirmed in the distributed consensus network. In the usual way, the further transaction record comes from an address associated with an origin node and indicates a destination address associated with another node. The destination may also be an address at the origin node itself, where the origin node retains control of the data. Typically the origin node proves their ownership of the transaction record by showing that they are the destination referred to in the previous transaction record with that data, which may utilise the usual blockchain method of locking transactions using a private key. Privacy of data may also involve including, in the transaction record, some data encrypted using a private key associated with the node. This can be checked against the earlier transaction record, verifying the identity of the node.

In practice, any of a number of distributed consensus networks may be used for this purpose, for example, Bitcoin Core, Ethereum or the like. MultiChain is an example of a blockchain application which sits on top of the Bitcoin Core application program interface (API) and provides customisations to enable generic business application usage. The Bitcoin blockchain has been in use since 2008 and currently comprises more than 6000 network nodes and a blockchain size of around 55 GB. However, bitcoin was created as a cryptographic currency and as a result, BitCoin Core API was not developed to be generic in its application of use. In preferred applications, the chosen blockchain platform should address issues such as more granular permission management, customised business logic, blockchain growth and the ability to search on information within the block.

Since ail nodes in the network can have a full copy of all transaction records, there is inherently a clear audit trail, avoiding the need for a separate auditing process to occur. Moreover, since all nodes have their own copy of the ledger, there is no single data source, avoiding the inherent difficulties that arise with such an arrangement. The ledger copies are inherently identical (since changes can only be made by having a transaction record included in a block that is propagated across the network) therefore there is no need for a separate reconciliation process.

The supply chain related to aspects of the present invention is a collection of entities (also referred to as ‘actors’) which may have specific roles and responsibilities as described above and may transfer assets uniquely associated with respective digital certificates. Typically, not all entities associate with nodes of the network are authorised to perform the same functions associated with an asset, such as for example manufacturing an item of a specific type, transferring the asset to another entity, or receiving an asset from another entity. The security of the system is increased over conventional systems by associating supply chain entities with a distributed consensus network and using predefined functions which differ between entities according to their roles within the supply chain.

Each of the entities may be associated with nodes of distributed consensus networks employed according to the invention. Each entity may have a personal vault also referred to as a ‘wallet’ for storing digital certificates uniquely associated with the asset that the entity owns. For each asset owned by an entity, that entity can initiate a transfer operation.

In some embodiments, the private distributed consensus network may include at least one ‘non-transactionar node’. The non-transactional node is typically a dedicated reporting node associated with any entity and there may be more than one such nodes (as each entity may have at least one reporting node) as entities may have different requirements and preferences for exporting data and they may have access to only certain parts of the data. The ledger is maintained by nodes within the private network except the at least one non-transactional node. Including a non-transactional node provides a performance advantage. The non-transactional node may contain a read-only copy of the ledger for example, but it does not take part in transactions or the consensus algorithm of the distributed consensus network. Queries can therefore be performed on the non-transactional node without impacting the performance of the entire network (i.e. blockchain). The function of the non-transactional node may be a dedicated reporting node whose purpose is extraction of data to enable reporting for example. The non-transactional node may be updated when a transaction take place and as part of this update, the non-transactional node verifies that the new block is valid and an authentic part of the chain but does not take part in the process of validating a transaction by a consensus of other nodes on the network. An additional function of the non-transactional node may be to verify the authenticity of an asset, license or product, for example.

Various ownership transfer operations related to transferring assets between entities of a supply chain using a private and a public distributed consensus network will now be described.

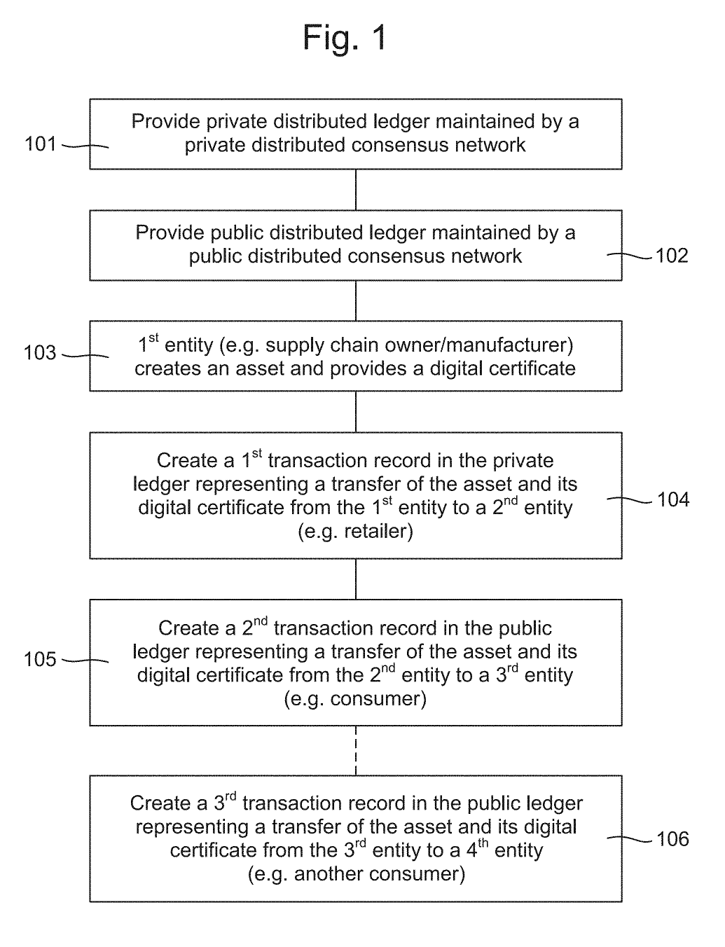

FIG. 1 shows a computer-implemented method for processing an asset within a supply chain, using distributed ledger of transaction records, the ledgers being respectively maintained by devices in public and private distributed consensus networks. The method will typically be performed by an application running on a suitably enabled computer.

At step 101 there is provided a private distributed ledger maintained by a distributed consensus network, and a step 102 there is a provided a public distributed ledger maintained by a distributed consensus network. In this example, the public distributed network is implemented as one or more blockchains forming two-way pegged sidechain(s) to a parent blockchain of the private distributed consensus network. Sidechains which enable assets to be transferred between blockchains are described in Adam Back et al., “Enabling Blockchain Innovations with Pegged Sidechains” (2014) which is also incorporated by reference. A sidechain is a blockchain that can validate data from other blockchains. A two-way peg refers to any mechanism by which an asset may be transferred between the linked chains and back. A pegged sidechain is a sidechain whose assets can be imported from and returned to other chains; that is a sidechain that supports two-way pegged assets.

Assets which are moved between the sidechain and the parent chain are able to be moved back by the current owner. An asset transfer is atomic, that is it happens entirely or none at all. Preferably, a sidechain is firewalled such that any bug in the sidechain enabling illegitimate creation or theft in that chain should not result in the illegitimate creation or theft of assets on any other chain. Pegged sidechains provide proof of possession in the transfer transaction themselves, avoiding the need of nodes to track back the sending chain. For example, when moving an asset from one blockchain to another, a transaction may be created in the first blockchain (e.g. the private blockchain), then a transaction is created on the second blockchain (e.g. the public blockchain) whose inputs provide cryptographic proof that the transaction was performed correctly, it will be appreciated however, that other implementations of linking two distributed consensus network may only require a transaction record to be recorded in the second network (e.g. the public network).

The first and second distributed consensus networks may be respectively configured to be maintained via an abstract (or abstraction) layer for example. In other words, an abstract layer may be used to configure the underlying blockchain technology.

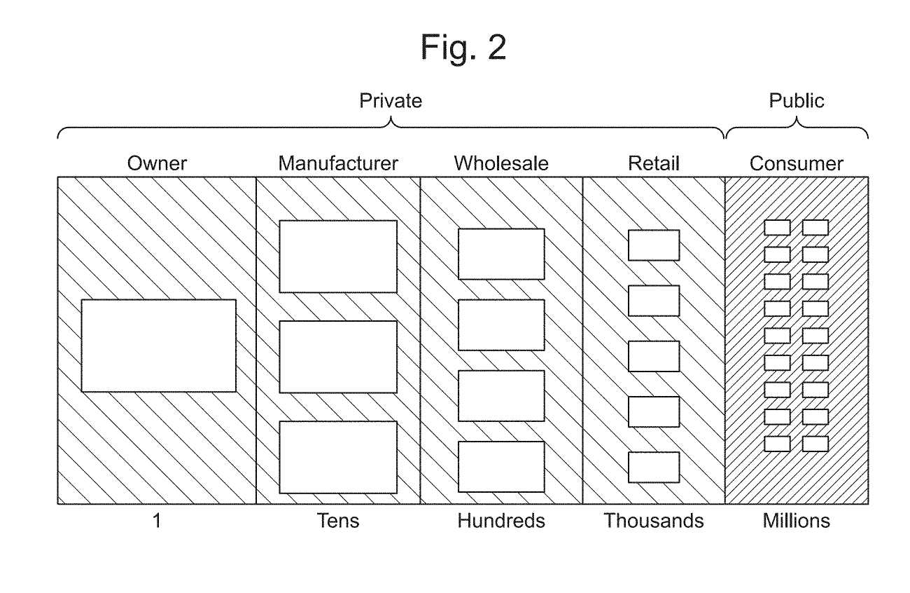

Each entity of a supply chain is associated with at least one node of either the first or second distributed consensus network. Typically, the supply chain includes one owner, and many manufacturers, wholesalers and retailers, whilst the number of consumers can reach millions for example, as schematically shown in FIG. 2.

In some embodiments, the distributed consensus network includes at least one ‘non-transactional’ node'. The non-transactional node is typically a dedicated reporting node associated with any entity and there may be more than one such nodes (as each entity may have at least one reporting node) as entities may have different requirements and preferences for exporting data and they may have access to only certain parts of the data. The ledger is maintained by nodes within the private network except the at least one non-transactional node. Including a non-transactional node provides a performance advantage. The non-transactional node may contain a read-only copy of the ledger for example, but it does not take part in transactions or the consensus algorithm of the distributed consensus network. Queries can therefore be performed on the non-transactional node without impacting the performance of the entire network (i.e. blockchain). The function of the non-transactional node may be a dedicated reporting node whose purpose is extraction of data to enable reporting for example. The non-transactional node may be updated when a transaction take place and as part of this update, the non-transactional node verifies that the new block is valid and an authentic part of the chain but does not take part in the process of validating a transaction by a consensus of other nodes on the network. An additional function of the non-transactional node may be to verify the authenticity of an asset, license or product, for example.

Going back to the method of FIG. 1, at step 103, a first entity of the supply chain, such as the owner creates and asset such as an item or a license to manufacture the item and provides a digital certificate uniquely associated with the asset.

For example, a supply chain owner may have created a blockchain and then authorised other nodes to connect. The blockchain is scalable so that additional nodes may be added to the blockchain as required. Adding a new node associated with an entity may comprise generating a secret key having a corresponding public key. Each node contains a copy of the blockchain ledger.

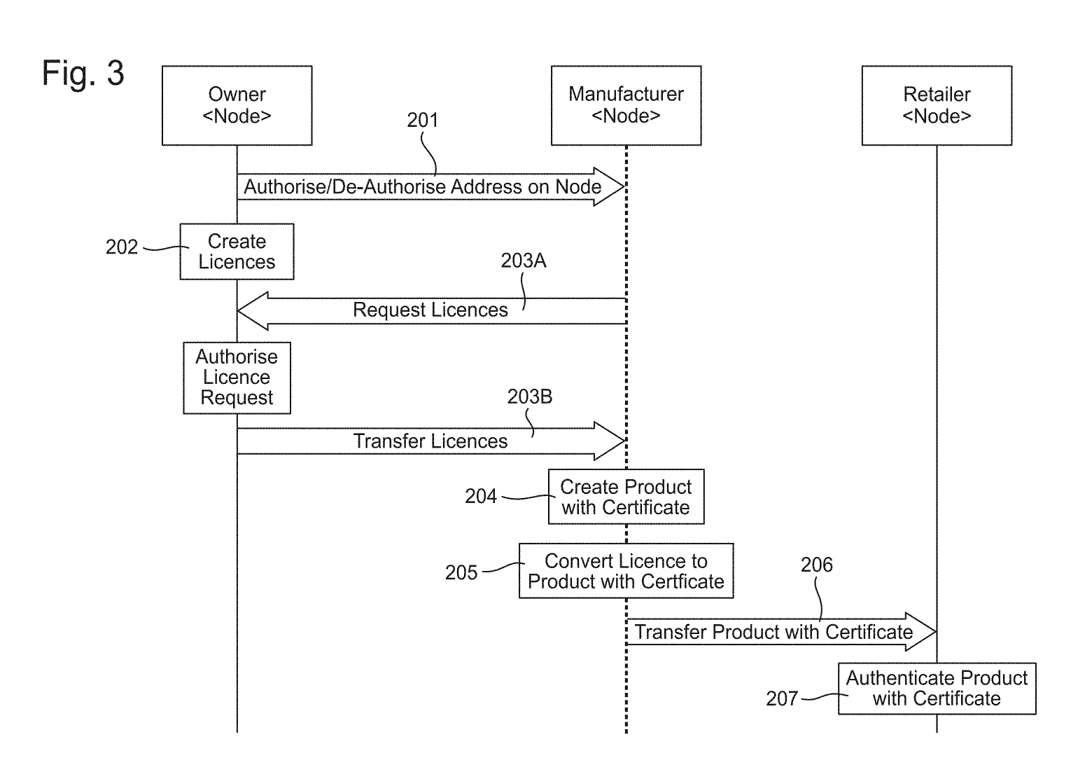

The supply chain owner can define the permissions (roles) or functions of each entity of the supply chain and control the supply of digital certificates. In some instances the owner may allow for ‘granular’ permissions for different entities, or nodes. By ‘granular’ we mean that the different permissions are granted through addresses on a node associated with an entity, for example as shown in FIG. 3. There may be multiple addresses on a single node for example a node could have an address for the function of manufacturing an asset and a second address for the function of receiving a license. There are many advantages to granular permissions. For example, a supply chain owner could use granular permissions to prevent an authorised manufacturer from transferring a license to another party, or it can control who the manufacturer can supply or the type of product certain retailers can sell. Alternatively, the first entity may be a manufacturer for example, which creates a product and provides a digital certificate uniquely associated with the product. The first entity is associated with a node of the private distributed consensus network. Defining any entity of the supply chain including the first entity for example may comprise generating a secret key having a corresponding public key.

A transaction record on the distributed ledger may include for example a transaction ID and a public key of the node associated with the entity receiving the asset. Preferably, the transaction record includes a public key associated with both the sender and the receiver.

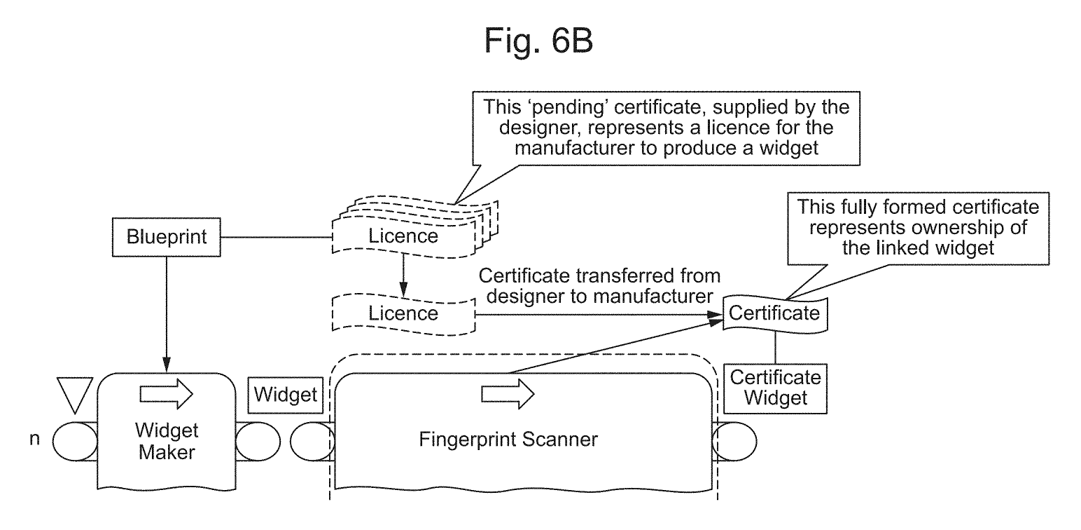

Associating the digital certificate with the asset may comprise generating a unique identification code from one or more properties of the digital certificate and applying the unique identification code to the asset. Alternatively, associating the digital certificate with the asset may comprise generating a unique identification code from one or more properties of the asset and incorporating the code in the digital certificate. Ways of associating the digital certificate and the asset will be described in more detail below, with reference to FIGS. 6A and 6B.

In some cases, an asset such as a physical item is associated with a unique digital certificate identified by a unique identifier such as a code containing alphanumerical characters. The unique identifier may be printed on the item or printed on a label or other secure document which is attached or adhered to the item. The unique codes are preferably randomly generated and can take the form of any known coding system such as a one dimensional barcode, two dimensional matrix barcode, such as a QR code or a Data Matrix code, or any known mechanism for the encryption of data using symbols, images or patterns. The unique identifier may be visible in daylight on the asset or applied label or it may be overt and only visible when excited by non-visible radiation such as ultra-violet or infra-red radiation. All physical transfers are accompanied by a transaction of digital certificate transfer in the distributed ledger. Typically, authorised entities of the supply chain are able to request the history of ownership for a particular item and thus check if the current owner is legitimate and if the item was legitimately produced.

For example, the unauthorised production of goods may be prevented through the issuance of digital certificates in the form of tokens by the product designer supply chain owner to its authorised manufacturers. Each digital token represents a license to produce a single physical item. Each digital token will be permanently associated with a single physical item during production. From this point, the transfer of ownership of its associated digital token will accompany any transfer of ownership of a physical item.

Going back to the method of FIG. 1, at step 104, a first transaction record is created in the private distributed ledger. The first transaction record represents a transfer of the asset together with its associated digital certificate (i.e. a transfer of a legitimate asset) from the first entity to a second entity of the supply chain. The second entity is associated with a node within the private distributed consensus network and in this example is a retailer of the supply chain.

At step 105, a second transaction record is created in the public distributed ledger. The second transaction record represents a transfer of the asset together with its associated digital certificate (i.e. a transfer of a legitimate asset) from the second entity to a third entity of the supply chain. The third entity is associated with a node within the public distributed consensus network and in this example is a consumer of the supply chain. Optionally, the second transaction record may be additionally recorded in the private distributed ledger.

At step 106, a third transaction record is created in the public distributed ledger. The third transaction record represents a transfer of the asset together with its associated digital certificate (i.e. a transfer of a legitimate asset) from the third entity to a fourth entity. The fourth entity is associated with a node within the public distributed consensus network and in this example is another consumer of the supply chain.

In some instances, the method may further comprises the step of creating a third transaction record in the second distributed ledger, the third transaction record comprising a third transaction identifier, the asset identifier and the identifier of a fourth entity of the supply chain associated with a node within the second distributed consensus network. That is, consumers for example may transfer products between each other.

In some instances, the method may further comprise creating a fourth transaction record respectively in the second distributed ledger, the fourth transaction record representing a transfer of the asset and its associated digital certificate from the third or fourth entity back to the second entity. For example, the owner of an asset in a public blockchain (i.e. a consumer), may transfer the asset back into the private blockchain.

In some embodiments, a public node in the second distributed consensus network may be configured to access a predetermined node in the first distributed consensus network in order to authenticate an asset. The predetermined node is typically associated with the supply chain owner in order to enable a consumer associated with the public node for example to access selected data related to authenticity of an asset for example and thus provide a further security advantage. For example, given an item serial number, any entity may request to see who is the current owner of the item and obtain a guarantee that the previous ownership history was legitimate. In some cases, this predetermined node is a non-transactional node.

Preferably, a consumer of the supply chain is able to verify the authenticity of the product by inspecting the public ledger or publicly accessible non-transactional node. For example the supply chain owner may have a public web-based application whereby a consumer (or anyone else for that matter) may enter or capture through other means such as by imaging the unique identifier on a label attached to the product to obtain a set of data confirming its authenticity. The unique identifier may be captured through a handheld device including personal digital assistants, tablet computers and in particular mobile telephones which are equipped with cameras and imaging software. The unique identifier may take the form of a 1D or 2D barcode such as QR code. A traditional one dimensional barcode merely requires a scan by an interrogating sensor. However, in the case of a matrix barcode such as a QR code the information presented is two dimensional, effectively requiring repeated scans in two dimensions or, more practically, an imaging sensor such as a camera on a smartphone.

Example Scenarios

FIG. 3 shows an example of a scenario involving nodes of a private distributed consensus network, associated with a supply chain owner, manufacturer and retailer, respectively. In this example, the owner issues assets in the form of licenses to manufacture a product and all nodes belong to a private blockchain.

At step 201, a node associated with a supply chain owner authorises connection of a nodes. The supply chain owner may add nodes for each participant on the private blockchain: owner, manufacturer, retailer in this example. Further, the supply chain owner may also add nodes for each participant on the public blockchain (e.g. consumer) which is linked to the private block chain according to the invention.

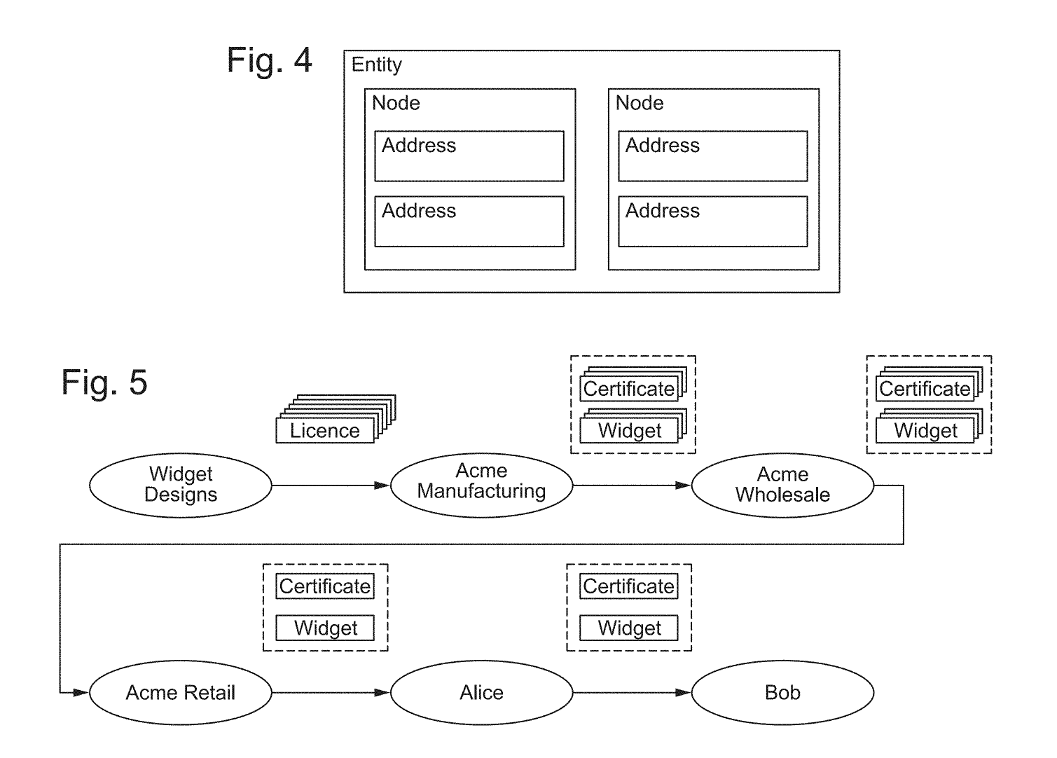

In addition to adding nodes, the supply chain owner may also authorise nodes for handling of assets (products, licences etc). Each participant or node on the blockchain contains one or more addresses as shown in FIG. 4, and each address maybe granted one or more of the following permissions: Connect, Send, Receive, Issue, Participate in the consensus algorithm, Activate, Admin. A node may have one or more addresses. The supply chain owner may also de-authorise addresses on nodes. In particular, permissions can be revoked from one or more addresses on a given node. In other words, as explained above, the permissions on an address are ‘granular’ in contrast to conventional systems where permissions are ‘global’, that is each address has the same rights.

At step 202, the supply chain owner creates a license to manufacture a product. For example, the supply chain owner may create rules for products and licences to ensure that, for example, only addresses on the manufacturer node may request and receive licences. This is critical for the supply chain operation and to control creation of licensed products.

In some examples, the transaction scripts may be provided by the Bitcoin Core API, and a blockchain application is preferably customised to this functionality. In the case of Bitcoin Core API, the underlying transaction fees cannot be turned off. Although transaction fees may well be useful within a supply chain, the transaction fees and the balance of the owners or manufacturer wallet in itself are not essential.

At step 203A, the manufacturer sends a request for a license to the owner and receives the license. Alternatively, the owner may transfer a number of licences to the manufacturer (step 203B). It will be appreciated that new licences can be issued from any address on a node that has been granted permission. Created licences are viewable at any node on the chain. Additional information can be added to the licence at the time of creation. This data could include the owner's name, description, or price for example. Each licence created must have a unique name, and the licence name must be unique within the blockchain it is being created in.

At step 204, the manufacturer creates a product together with a digital certificate uniquely associated with the product. New products can be issued to the chain from any address on a node that has been granted permission. Created products may be viewable at any node on the chain. Additional information can be added to the products at the time of creation. This data could include the product name, description, price for example. Each product created must have a unique name, and the product name must be unique within the blockchain it is being created in.

In some cases, entities may convert licenses to a certified product. The concept of exchanging a license to a certified product represents the ‘consuming’ of a quantity of an asset on the supply chain and the producing of another. For example, the manufacturer on a supply chain may exchange a licence for a certified produced product. Additional information could be added to the transaction to provide context around the transaction.

At step 206, the manufacturer transfers the created product and its associated digital certificate to the retailer (i.e. to an address of a node associated with the retailer). This transfer recorded in the private distributed ledger (as described at step 104 of FIG. 1).

At step 207, the retailer verifies the authenticity of the product. In some cases, the retailer node has access to the full transaction history of the certified product and would, therefore, be able to confirm its authenticity.

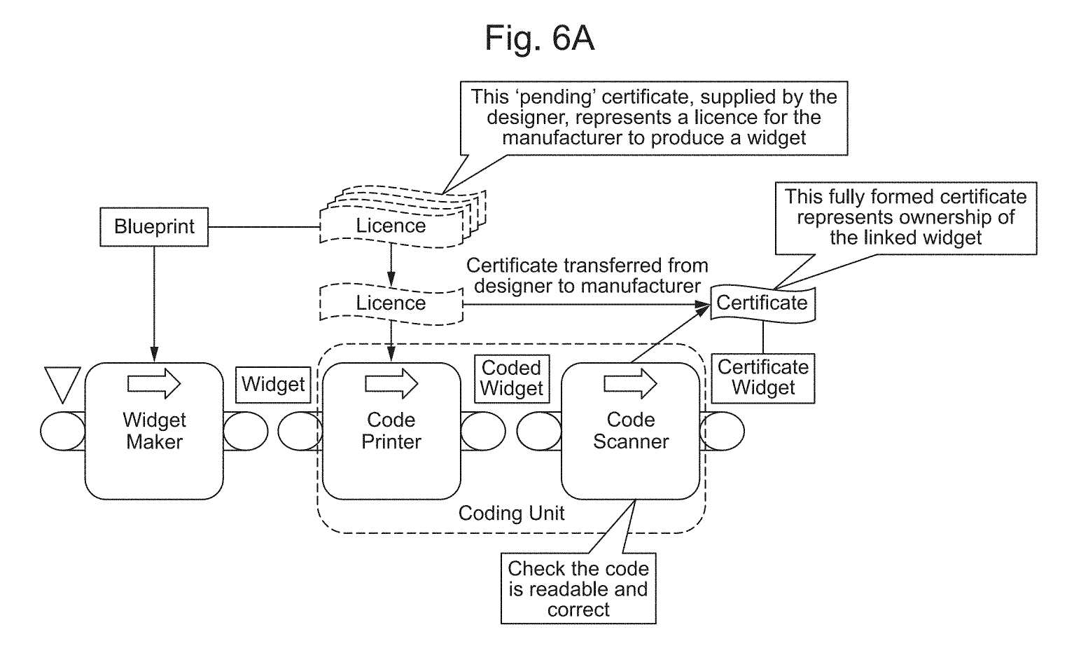

We now provide an example scenario which illustrates steps of FIG. 3 as described above. This example scenario additionally includes a wholesaler entity and is summarised in FIG. 5.

With reference to FIG. 5, Widget Designs is the supply chain owner and has designed a new product called Widget. Widget Designs selects Acme Manufacturing, that is a manufacturer, to make its Widgets under license. In order to supply Widgets to consumers, Widget Designs creates distribution agreements with Acme Retail (and optionally with Acme Wholesale). Widget Designs would like to ensure that Acme Manufacturing makes the correct number of Widgets in accordance with its licensing agreement.

Widget Designs would also like to ensure that every organisation in the Widget distribution channel, including the final consumer, is guaranteed to receive authentic Widgets. Accordingly, Widget Designs informs consumers, and every organisation in its supply chain that only those Widgets with an associated digital token are guaranteed to be authentic. To guarantee authenticity, no entity should accept a Widget without an associated digital token.

Widget Designs creates a blockchain node to issue Widget licenses to Acme Manufacturing. It issues Widget licenses as digital tokens. Each ‘license token’ grants Acme Manufacturing permission to make one Widget. Acme Manufacturing creates a blockchain node to receive Widget licenses from Widget Designs. When Acme Manufacturing makes a Widget, it creates a unique association between the license token and the Widget.

FIGS. 6A and 6B schematically illustrate the alternative ways of creating a unique association between an asset such as a product and the digital certificate. In FIG. 6A, a unique code is generated from one or more properties of a digital token and then applied to a widget representing an asset. The unique code may be applied directly to the widget or to the packaging for the widget or applied to a label which is adhered to the widget using a conventional label transfer process. The unique code may be printed using any known variable data printing technique or it may be created using a non-contact technique such as laser marking or laser ablation. The unique code may be encrypted with data which enables it to be linked with the digital certificate and hence enable subsequent verification when the code is read at a later point in the supply chain. In addition, the unique code may include other identifier information such as place of manufacture, date of manufacture or origin of raw materials etc.

In FIG. 6B, a unique code is generated from one or more properties of the widget and then applied to the digital token. The properties of the widget could include a unique characteristic of one of the materials forming the widget. For example if the widget was made from a material which contained a secure taggant such as a fluorescent fibre than the distribution of the fibre in a specified region could be used as unique characteristic. Optionally, the digital certificate may be signed with a secret key of the first entity, the secret ley having a corresponding public key.

To summarise the life of the Widget token to this point:

1. Widget Designs created the token.

2. Widget Designs sent the token to Acme Manufacturing.

3. Acme Manufacturing linked the token to a Widget.

Advantageously, it is impossible for Acme Manufacturing to produce more authentic Widgets than Widget Designs has granted authorisation for because a valid Widget must have a unique code, linked to the token that originated from Widget Designs. Further, it is impossible for any other organisation to produce authentic Widgets because only Acme Manufacturing has been issued with license tokens. The incentive to steal Widgets from the Manufacturer is reduced because legitimate entities will only buy Widgets that are accompanied by a digital token. The only way to ‘steal’ a digital token is to obtain the private key of the legitimate owner.

Acme Wholesale would like to take stock of a consignment of Widgets to distribute to retailers. In preparation for the introduction of Widgets to the market, Acme Wholesale has already created a node in the private blockchain and Acme Designs has granted Acme Wholesale permission connect its node to the blockchain. Acme Wholesale places an order on Acme Manufacturing for the required number of Widgets. Acme Manufacturing packs the required number of Widgets into a consignment and sends the corresponding collection of digital tokens to Acme Wholesale. Acme Wholesale receives the consignment and completes the transaction by verifying that it has received the linked Widget for each of its digital tokens.

Advantageously, it is impossible for Acme Wholesale to receive an illegitimate supply of Widgets because the valid transaction of the digital token for each Widget confirms that Acme Manufacturing is the source of the Widget, and that Acme Manufacturing was authorised to produce and distribute the Widget. As in the case of the manufacturer, the threat of product theft from the Wholesaler is reduced. This applies to all subsequent entities in the supply chain. Acme Retail would like to take stock of a number of Widgets to sell to consumers. The sequence of steps it follows are similar to those taken by Acme Wholesale.

A consumer, Alice, would like to buy a Widget from the Acme Retail store. In preparation for the purchase, Alice has downloaded the Acme Designs digital token app to her smartphone. The store assistant provides Alice with a Widget and allows her to scan its unique code using a smartphone application of the system for example. The application confirms that the Acme Retail store is the current owner of the Widget. Note that this implicitly confirms the authenticity of every previous transfer of this Widget, and even further, back to the creation of the license for Acme Manufacturing to make it. Alice pays for the Widget and the store assistant scans the address of Alice's digital token vault from her smartphone. The store assistant then scans the code from the Widget and sends its digital token to Alice's vault.

After a while, Alice decides to upgrade to a Widget 2.0. Alice advertises her old Widget on an online store and Bob decides he would like to buy it. Bob would like to verify the authenticity of the Widget before he commits to buy. On the advert, Alice has posted the Widget's code, together with the public address for her digital vault. Bob scans these with the smartphone app and the application verifies that this is an authorised Widget and its digital token is held at the given address. Bob orders the Widget from Alice and supplies her with the public address of his digital vault. Alice ships the Widget to Bob and sends him the digital token. Bob receives the Widget and completes the transaction by verifying that the Widget he has received is linked to the digital token.

System Implementation

A system implementing the invention may comprise a processor and a memory in communication with the processor. The memory stores instructions which, when executed by the processor, cause the processor to perform a method as described above.

In particular, the method may be implemented by specific tools to inspect the respective ledger transactions, such as web-based applications. Each type of supply chain entity (owner, manufacturer, distributor, retailer, consumer) may have a dedicated user interface, such as a web-based application, in some cases a mobile application. An abstract layer may be used to change the underlying blockchain technology. Preferably, supply chain metadata is described in a configurable way and ideally the user interfaces provide a way to define new supply chain entities. Alternatively, supply chain metadata may be configurable at the database layer without the need to change the application code. Preferably, for the chosen blockchain technology, it is relatively straightforward to add or remove ledger nodes.

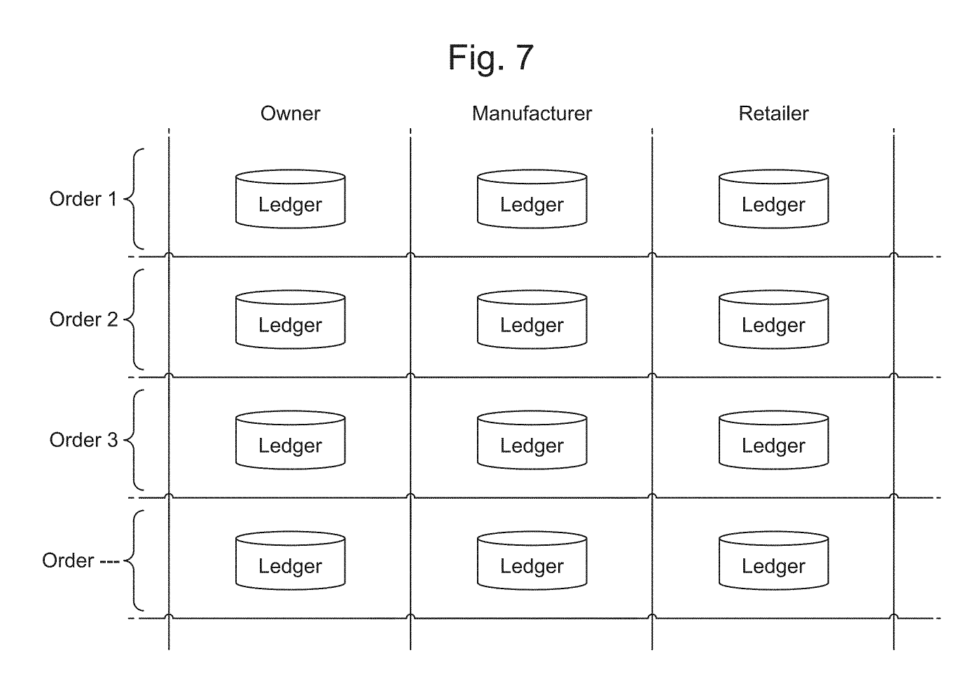

Two possible configurations for supply chain management are envisaged. In a first implementation, the private and public distributed consensus networks are each implemented as a respective single blockchain (i.e. single ledger) used for all assets and transactions. Alternatively, a blockchain ledger may be used for each order or transaction, as illustrated in the example of FIG. 7.

A single ledger has the advantages that it requires less configuration management overhead and lower complexity for configuration and usability. A disadvantage of this configuration is that the ledger size continually increasing unless pruning of the blockchain is supported. A network must contain a number of full nodes if pruned nodes are also to be used.

By pruning we mean any technique that allows a blockchain to remove older transactions to ensure that the blockchain is smaller in data size. In particular, pruning is the process of removing old blocks from the blockchain. Pruning works by setting a maximum disk size, for example 550 MB or more. As the node starts to synchronise (pulling the blockchain from an existing full node) once it reaches 550 MB, or the defined limit, the oldest blocks are deleted to maintain the maximum size specified. It is important to note that not all nodes on a blockchain network may be pruned. There are several reasons why the full blockchain will be required, as listed below:
Relay blocks to other nodes, for example when adding a node to a network.
Handle reorganisations. This is a node-specific phenomenon, when a node discovers another node with a well-formed blockchain, which excludes some blocks which were previously thought were part of the blockchain. At this point the node will orphan the offending blocks.
Look up old transactions. For example, on the supply chain a product may not have changed owners for a long period of time. However, when it does so the need exists to be able to verify the current owner of the item and ascertain its authenticity.
Rescanning the wallet. This may be required if the wallet has been backed up at some point and then restored. The issue will be that any transactions in blocks that affect the wallet would not have been applied once restored, hence a rescan is required. In other words, consider the following scenario: the wallet is backed-up, then perform a transaction is performed to transfer ownership of an asset to the node with the wallet. If the wallet is restored from the backup, the transaction will not have been applied to the wallet.

Conversely to the single chain implementation, a ledger per order or transaction configuration has the advantages that the ledger size will always be small and of allowing for archiving of data. On the other hand, the disadvantages of this configuration, is that it requires more configuration management overhead and higher complexity for configuration.

1. A computer-implemented method for processing an asset within a supply chain, the method comprising:
providing a first distributed ledger, the first distributed ledger being maintained by nodes within a first distributed consensus network;
providing a second distributed ledger, the second distributed ledger being maintained by nodes within a second distributed consensus network,
creating the asset by a first entity of the supply chain, the first entity being associated with at least one node within the first distributed consensus network, and providing a digital certificate uniquely associated with the asset for authentication of the asset;
creating a first transaction record in the first distributed ledger, the first transaction record representing a transfer of the asset and its associated digital certificate from the first entity to a second entity of the supply chain, the second entity being associated with at least one node within the first distributed consensus network; and
creating a second transaction record in the second distributed ledger, the second transaction record representing a transfer of the asset and its associated digital certificate from the second entity to a third entity of the supply chain, the third entity being associated with at least one node within the second distributed consensus network.

2. A method according to claim 1, wherein the first and second distributed consensus networks are respectively implemented as one or more blockchains, and wherein the one or more blockchains of the first distributed consensus network are implemented as one or more two-way pegged sidechains to a parent chain represented by a blockchain of the second distributed consensus network.

3. A method according to claim 1, further comprising creating a third transaction record in the second distributed ledger, the third transaction record comprising a third transaction identifier, the asset identifier and the identifier of a fourth entity of the supply chain associated with a node within the second distributed consensus network.

4. A method according to claim 1, further comprising, creating a fourth transaction record respectively in the second distributed ledger, the fourth transaction record representing a transfer of the asset and its associated digital certificate from the third or fourth entity back to the second entity.

5. A method according to claim 1, wherein associating the digital certificate with the asset comprises generating a unique identification code from one or more properties of the digital certificate and applying the unique identification code to the asset.

6. A method according to claim 1, wherein associating the digital certificate with the asset comprises generating a unique identification code from one or more properties of the asset and incorporating the code in the digital certificate.

7. A method according to claim 1, wherein providing a digital certificate comprises signing the digital certificate with a secret key of the first entity, wherein the secret key has a corresponding public key.

8. A method according to claim 1, wherein a node in the second distributed consensus network is configured to access a predetermined node in the first distributed consensus network in order to authenticate an asset.

9. A method according to claim 1, wherein the second entity is the only entity of the supply chain associated with at least one node within the first distributed consensus network, which may transfer the asset and its associated digital to the third entity.

10. A system comprising a processor and a memory in communication with the processor, the memory storing instructions which, when executed by the processor, cause the processor to perform the method of claim 1.

11. A supply chain comprising a plurality of entities, wherein an asset is processed according to the method of claim 1.

12. A system for processing an asset within a supply chain comprising one or more entities, the system comprising:
a first distributed ledger being maintained by nodes within a first distributed consensus network; and
a second distributed ledger being maintained by nodes within a second distributed consensus network,
wherein a first entity associated with at least one node within the first distributed consensus network is configured to create an asset;
wherein the first distributed ledger being is configured to record a first transaction record representing a transfer of the asset from the first entity to a second entity of the supply chain; and
wherein the second distributed ledger is configured to record a second transaction record representing a transfer of the asset from the second entity to a third entity of the supply chain, the third entity being associated with at least one node within the second distributed consensus network,
wherein only the second entity is the only entity of the supply chain associated with at least one node within the first distributed consensus network, which may transfer the asset and its associated digital to the third entity,
wherein the second entity is the only entity of the supply chain associated with at least one node within the first distributed consensus network, which may transfer the asset and its associated digital to the third entity.

13. A system according to claim 12, wherein the first entity is further configured to provide a digital certificate uniquely associated with the asset for authentication of the asset.

14. A system according to claim 13, implementing a method for processing an asset within a supply chain, the method comprising:
providing a first distributed ledger, the first distributed edger being maintained by nodes within a first distributed consensus network;
providing a second distributed ledger, the second distributed ledger being maintained by nodes within a second distributed consensus network,
creating the asset by a first entity of the supply chain, the first entity being associated with at least one node within the first distributed consensus network, and providing a digital certificate uniquely associated with the asset for authentication of the asset;
creating a first transaction record in the first distributed ledger, the first transaction record representing a transfer of the asset and its associated digital certificate from the first entity to a second entity of the supply chain, the second entity being associated with at least one node within the first distributed consensus network; and.
creating a second transaction record in the second distributed ledger, the second transaction record representing a transfer of the asset and its associated digital certificate from the second entity to a third entity of the supply chain, the third entity being associated with at least one node within the second distributed consensus network.
